(19) United States
(12) Patent Application Publication
(10) Pub. No.: US 2013/0247743 A1
(43) Pub. Date: Sep. 26, 2013

(54) Sleeve for Contact with Tuning Pegs and Process for Sleeve Interaction with Tuning Peg

(71) Applicant: Jeffrey Milone, Wall, NJ (US)

(72) Inventor: Jeffrey Milone, Wall, NJ (US)

(21) Appl. No.: 13/466,080

(22) Filed: May 7, 2012

Related U.S. Application Data
(60) Provisional application No. 61/483,399, filed on May 6, 2011.

(51) Int. Cl. G10D 3/14

(52) U.S. Cl. CPC G10D 3/14
USPC 84/304

(57) ABSTRACT

A flexible sleeve for placement around at least a portion of a tuning peg of an instrument, the sleeve comprising: a base with four sides connecting to the base which can be secured to the end of a tuning peg; the sleeve being made from flexible material to enable the base and sides to encase at least the end portion of the tuning peg; and the base and slides forming a grip over the tuning peg, wherein the user of the tuning peg has increased contact and manipulation of the tuning peg.

This application claims the benefit of provisional U.S. application Ser. No. 61/483,399, filed May 6, 2012, which is incorporated herein by reference in its entirety as if reproduced in full in this application.

### FIELD OF THE INVENTION

This invention relates to a sleeve for application to tuning pegs of musical instruments, such as a guitar, to improve the performance of the tuning peg, usability by the user of the guitar and add tuning features to the musical instrument.

### SUMMARY OF THE INVENTION

Protective, flexible covers for a guitar or any string instrument's tuning pegs. The covers, which may be called “sleeves”, “covers”, “socks”, or “slip-ons” may also incorporate some type of microchip that enables the user to tell if a particular string is in tune at any given moment. In another embodiment, the material does not need to be flexible or removable. It can simply be a new type of peg with a microchip tuner embedded within it.

In another embodiment, the sleeves could visually enhance performances in a number of different ways. For example, the sleeves could light up when the strings are played, could glow in the dark or under black light and could even send out laser beams creating laser beams when the instrument is played.

Tuning pegs on stringed musical instruments can be damaged, scratched, or even broken off due to their unprotected exposure on the end of the instrument. They can also be difficult to grip and turn due to the slick nature of their metal surfaces. Also, one cannot tell if a string on a tuning peg corresponding to a particular note is in tune without using some type of electronic or manual tune.

### SUMMARY OF THE INVENTION

My invention, which may be called a “sleeve”, is a flexible material that snugly fits over the tuning peg and cushions it in the event of an impact on the peg. The sleeve would also protect the peg from being scratched, damaged or broken off. Another embodiment of the sleeve would incorporate a microchip that is embedded inside it that will signal when that particular string is in or out of tune, thereby eliminating the need for an electric or manual tuner. Thus, one could instantly tune the instrument based on signals from the sleeves, even while playing the instrument.

The microchip could be activated using pressure and then signal (i.e., blinking colored light) when the string is either in or out of tune. The microchip would detect movement of the peg for potential out of tune, or the string may change and stretch as one plays, so the tuning peg would not move but the string would become out of tune. When the string is in tune, there would be no signal. If the string is out of tune, the sleeve would visually indicate this by changing color, blinking, glowing, etc. until it was tuned correctly.

### BRIEF DESCRIPTION OF THE DRAWINGS

Other aspects, features and advantages of the present invention will become more fully apparent from the following detailed description, the appended claim and the accompanying drawings in which:

FIG. 1 is a representation of a sleeve version of one embodiment of the invention sleeve 1 with sides 10.

FIGS. 2a, 2b, and 2c are representations of a sleeve 5 with sides 10 and a base 20 version of an alternative embodiment of the invention.

FIGS. 3a, 3b, 3c, and 3d are representations of a sleeve 25 with an ergonomic and modeled shape to increase the conformance with an exemplary tuning peg. FIG. 3a shows a sleeve 25 with numerous sides 34 and 36 as the core sides and base 30 with the inclined portions 38 being either part of the base or the sides and an entry part of the sleeve with ends 32 and an opening 35. FIGS. 3b, 3c and 3d show the same sleeve 25 from different angles, which reveals the sides to a greater degree.

FIG. 4 is a sample sleeve 25 made a semi-transparent rubber.

FIG. 5 is a sample sleeve 25 placed next to a guitar tuning peg 40 demonstrating the molding of the sleeve 25 to conform to the rotatable portion 42 of the tuning peg.

FIG. 6 is a sample sleeve 25 partially applied to the rotating portion of the tuning peg 42. The sleeve 25 conforms rotatable portion 42 to enable greater manipulation by the user of the guitar and protection of the rotatable portion 42 as a component of the tuning peg 40.

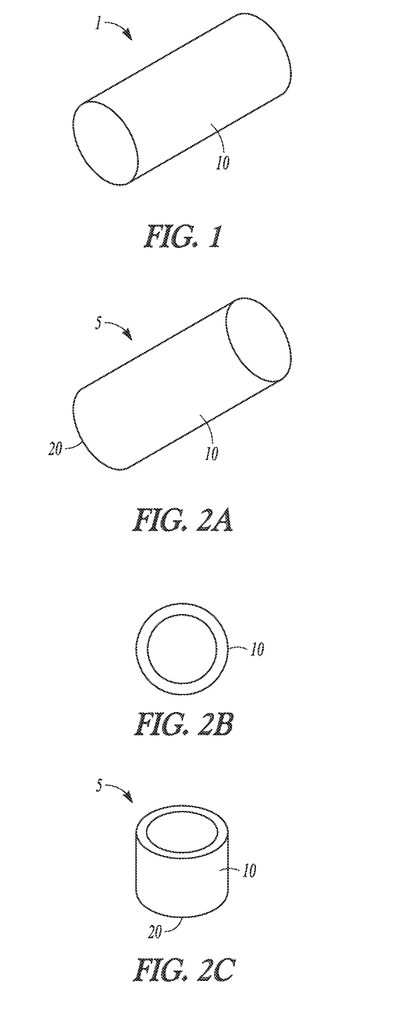

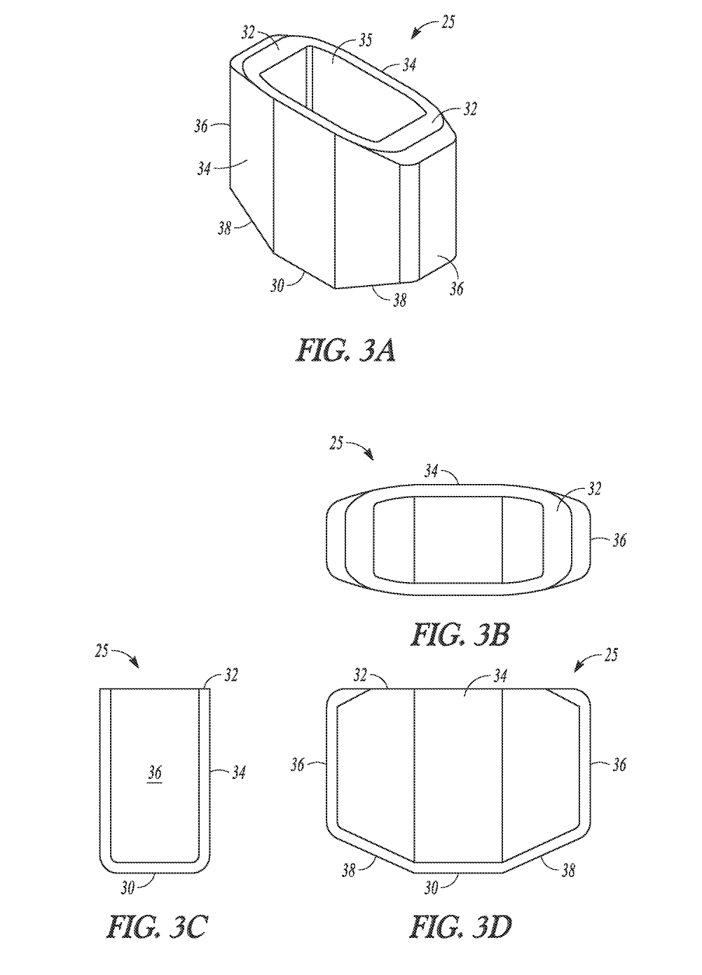

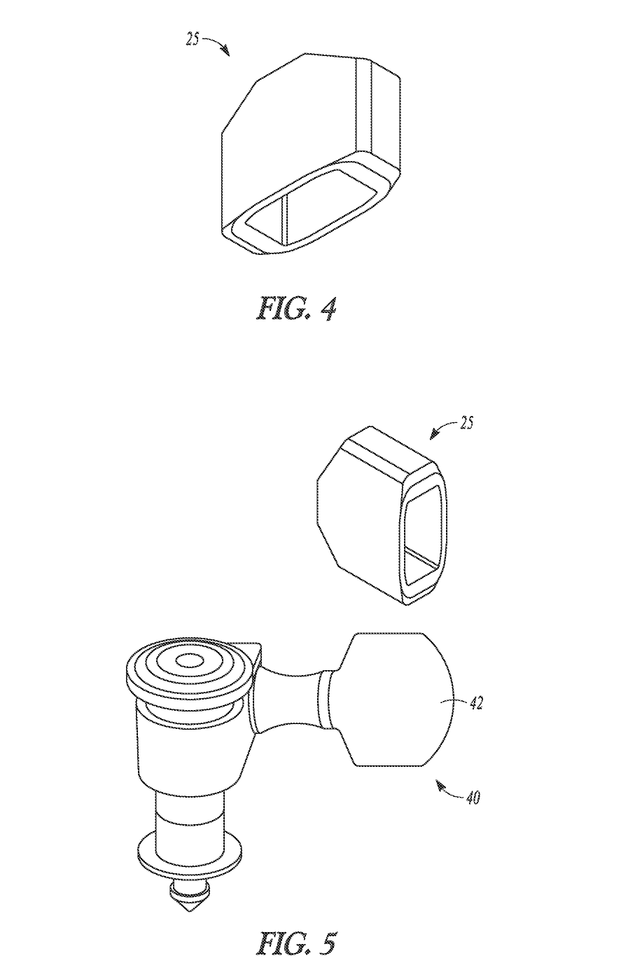

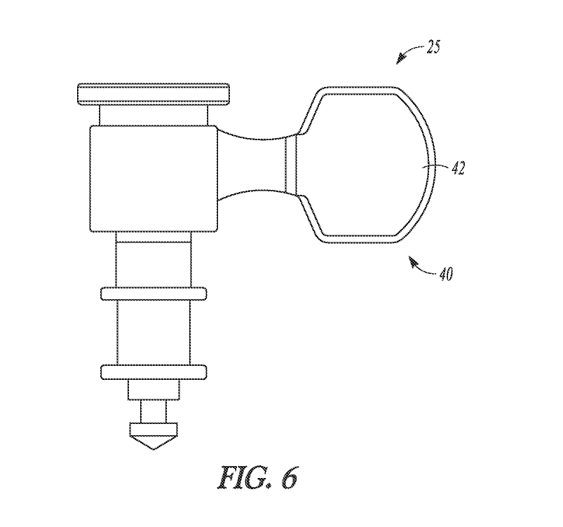

### DETAILED DESCRIPTION OF THE INVENTION

Please refer to the drawings in the Brief Description of the Drawings section and the figures in the provisional application to which this application is based. The sleeve 25 is a one piece, flexible cover that fits over any standard tuning peg. The dimensions will conform to the shape of the underlying tuning peg. The sleeve will consist of some type of rubber, silicon, pvc and/or plastic material, but could be made of almost any material. In sleeves or pegs made for tuning, a microchip would be embedded within the sleeve.

The sleeve 25 can consist of a single component made of some type of flexible material (e.g., rubber, silicon, latex, pvc, etc.). The sleeve will slip over the tuning peg and conform snugly to the shape of the tuning peg.

The invention protects the tuning peg by physically covering it and providing shock absorption in the event of trauma to the peg. Another embodiment of the sleeve would incorporate a microchip inside it that would tell the musician if a particular string was in or out of tune at any given moment. The chip inside the sleeve would light up, blink, vibrate, etc. to alert the musician. If used to enhance the visual performance of the player, the sleeve could incorporate a microchip that changes color, flashes or emits laser/LED light as the instrument is played or at any time the player chooses.

To make the invention, one would fabricate some type of peg-shaped template that would then be dipped into the flexible material and allowed to cure. Another process would entail the fabrication of molds conforming to the shape of the tuning peg. The flexible material would then be injected into the mold and allowed to cure. Once the sleeve is created, one could embed a microchip within it if the device was to be used for tuning the instrument as well.

A person would slip the sleeves over each tuning peg on the instrument, tune and play the instrument normally while leaving the sleeves in place to protect the pegs at all times. If the microchip tuners were embedded in the sleeves, the person would leave the sleeves in place for instantaneous tuning at any time and/or visual performance enhancement.

The following features can be found in alternative embodiments of the invention:
Microphone, if in tune, no signal on sleeve. Microchip would detect movement of the peg for potential out of tune, or string may change and stretch as play so the tuning peg would not move but the strings would become out of tune.
Put microchip/sleeve on, tune string, squeeze sleeve to activate the baseline tuning level, if microchip determines that moves away from baseline tuning level, then indicates to player. Microphone for each note.click a number of times for each note or each pitch. Squeezing it gives different notes.
Microchip, if in tune, no signal, visually show that tuning is out of tune, change color, glow, blinking light
visually enhance performances by sleeves lighting while playing the strings, so the sleeves light up when a string is played. Glow in the dark, glow under black. Pegs lighting could also be a laser to send out laser beams from the handle of the guitar creating stage effects when the instrument is played.
strings light up based on the microchip in the sleeve to enhance the visual performance of the guitarist
sleeve areas that have buttons to set the microchip to the right note or pitch
sleeve has holes or other surface features for reasons . . . e.g., hole so it is not a choking hazard
website to enable the guitarist to design his own sleeves (any unique features here?)

Protective, flexible sleeves for tuning pegs (with or without microchip tuners) improve upon the functionality of tuning pegs in the ways described herein.

I claim:

1. A flexible sleeve for placement around at least a portion of a tuning peg of an instrument, the sleeve comprising:
a. a base with four sides connecting to the base which can be secured to the end of a tuning peg;
b. the sleeve being made from flexible material to enable the base and sides to encase at least the end portion of the tuning peg; and
c. the base and slides forming a grip over the tuning peg, wherein the user of the tuning peg has increased contact and manipulation of the tuning peg.

2. The flexible sleeve of claim 1, wherein the sleeve sides do not extend to the opposite end portion of the tuning peg with the sleeve encasing the tuning peg at one of less than one of 20%, 30%, 50%, 70%, 80% or any percentage in between the number.

3. The flexible sleeve of claim 1, wherein the material has a contact element wherein the sleeve grips the tuning peg without having to encase the entire tuning peg.

4. The flexible sleeve of claim 1, wherein the four sides are contiguous and form a cylinder.

5. The flexible sleeve of claim 1, wherein the sleeve sides extend to the end portion of the tuning peg opposite the end portion furthest away from the connection to the musical instrument.

6. The flexible sleeve of claim 1, wherein the base includes a hole.

7. A flexible sleeve for placement around at least a portion of a tuning peg of an instrument, the sleeve comprising:
a. a cylinder which can be secured to the sides of a tuning peg;
b. the sleeve being made from flexible material to enable the cylinder sides to encase at least the sides of the tuning peg; and
c. the slides forming a grip over the tuning peg, wherein the user of the tuning peg has increased contact and manipulation of the tuning peg.

8. The flexible sleeve of claim 7, wherein the sides do not extend to the opposite end portion of the tuning peg with the sleeve encasing the tuning peg at one of less than one of 20%, 30%, 50%, 70%, 80% or any percentage in between the number.

9. The flexible sleeve of claim 7, wherein the material has a contact element wherein the sleeve grips the tuning peg without having to encase the entire tuning peg.

10. The flexible sleeve of claim 7, wherein the four sides are contiguous and form a cylinder.

11. The flexible sleeve of claim 7, wherein the sleeve sides extend to the end portion of the tuning peg opposite the end portion furthest away from the connection to the musical instrument.

12. A sleeve for placement around at least a portion of a tuning peg of an instrument, the sleeve comprising:
a. a cylinder which can be secured to the sides of a tuning peg;
b. the sleeve being made from material to enable the cylinder sides to encase at least the sides of the tuning peg; and
c. the slides forming a grip over the tuning peg, wherein the user of the tuning peg has increased contact and manipulation of the tuning peg.

13. The sleeve of claim 12, wherein the sides do not extend to the opposite end portion of the tuning peg with the sleeve encasing the tuning peg at one of less than one of 20%, 30%, 50%, 70%, 80% or any percentage in between the number.

14. The sleeve of claim 12, wherein the material has a contact element wherein the sleeve grips the tuning peg without having to encase the entire tuning peg.

15. The sleeve of claim 12, wherein the four sides are contiguous and form a cylinder.

16. The sleeve of claim 12, wherein the sleeve sides extend to the end portion of the tuning peg opposite the end portion furthest away from the connection to the musical instrument.

17. A sleeve for placement around at least a portion of a tuning peg of an instrument, the sleeve comprising:
a. a cylinder which can be secured to the sides of a tuning peg;
b. the sleeve being made from material to enable the cylinder sides to encase at least the sides of the tuning peg;
c. the slides forming a grip over the tuning peg, wherein the user of the tuning peg has increased contact and manipulation of the tuning peg; and
d. the sleeve including a microchip that senses the tuning accuracy of the string associated with the tuning peg and provides information based on at least one of visually, audibly, sending data to a device, laptop, smartphone application to indicate the status of tuning of the string associated with the tuning peg.
